(19) United States
(12) Patent Application Publication
(10) Pub. No.: US 2012/0220309 A1
(43) Pub. Date: Aug. 30, 2012

(54) POSITIONING APPARATUS, POSITIONING METHOD AND COMPUTER PROGRAM PRODUCT THEREOF

(75) Inventors: Sheng-Cheng YEH, Taoyuan County (TW); Jhe-Sian SIE, Taipei County (TW); Cheng-En HONG, Taipei City (TW)

(73) Assignee: INSTITUTE FOR INFORMATION INDUSTRY, Taipei (TW)

(21) Appl. No.: 13/154,168

(22) Filed: Jun. 6, 2011

(30) Foreign Application Priority Data
Feb. 25, 2011 (TW) 100106381

(51) Int. Cl. H04W 4/02

(52) U.S. Cl. 455/456.1

(57) ABSTRACT

A positioning apparatus, a positioning method, and a computer program product thereof are provided. The positioning apparatus is used to calculate a self-position. The positioning apparatus can communicate with a reference apparatus and comprises a transceiving unit, a storage unit and a processing unit. The transceiving unit is configured to receive a received signal strength indicator (RSSI) from the reference apparatus. The storage unit is configured to store attenuating factor data. The processing unit is configured to retrieve an attenuating factor corresponding to the RSSI from the attenuating factor data and calculate the self-position according to the RSSI and the attenuating factor.

### PRIORITY

This application claims priority to Taiwan Patent Application No. 100106381 filed on Feb. 25, 2011, which is hereby incorporated herein by reference in its entirety.

### FIELD

The present invention provides a positioning apparatus, a positioning method and a computer program product thereof. More particularly, the present invention provides a positioning apparatus, a positioning method and a computer program product thereof for computing a self-position.

### BACKGROUND

Over recent years, due to the advancement of mobile communication technologies and widespread use of various wireless communication terminals, a variety of applications of mobile positioning services have experienced rapid development. Accordingly, by means of a wireless communication terminal (e.g., a mobile phone, a navigator, a notebook computer, or a tablet computer), a user can get the position information where he or she is located. Furthermore, with the aid of application software, such as an electronic map, various value-added positioning applications can be accomplished in real time, including personal value-added applications such as personal navigation, emergency rescue positioning and personal safety tracking, as well as commercial applications such as vehicle management and commodity monitoring.

Generally, conventional positioning technologies can be primarily classified into two groups. For the first kind of positioning technology, environmental signal features must be collected to establish a database, and then during the positioning process, a comparison is made against the signal features in the database to get a positioning result. However, it is very time-consuming to establish the database of signal features. For the second kind of positioning technology, a signal propagation model is used to measure the distance by describing the path loss attenuation as a function of a distance, and then the trilateration method is used to compute a positioning result. However, in this kind of positioning technology, the signal propagation models are all fixed, so a ranging error will occur when a signal propagation model does not conform to the actual path loss conditions, thus leading to an error in the positioning.

Accordingly, there is a need to provide a positioning method that conforms to the actual environmental factors and provides an improved positioning accuracy.

### SUMMARY

An objective of certain embodiments of the present invention is to provide a positioning apparatus for computing a self-position. The positioning apparatus is able to communicate with a reference apparatus and comprises a tranceiving unit, a storage unit and a processing unit. The transceiving unit is configured to receive a received signal strength indicator (RSSI) from the reference apparatus. The storage unit is configured to store attenuating factor data. The processing unit, which is electrically connected to the transceiving unit and the storage unit respectively, is configured to retrieve an attenuating factor corresponding to the RSSI from the attenuating factor data and compute the self-position according to the RSSI and the attenuating factor.

Another objective of certain embodiments of the present invention is to provide a positioning method for a positioning apparatus. The positioning apparatus is used to compute a self-position and is able to communicate with a reference apparatus. The positioning apparatus comprises a transceiving unit, a storage unit and a processing unit. The storage unit is configured to store attenuating factor data. The processing unit is electrically connected to the transceiving unit and the storage unit respectively. The positioning method comprises the following steps: (a) enabling the transceiving unit to receive a RSSI from the reference apparatus; (b) enabling the processing unit to retrieve an attenuating factor corresponding to the RSSI from the attenuating factor data; and (c) enabling the processing unit to compute the self-position according to the RSSI and the attenuating factor.

A further objective of certain embodiments of the present invention is to provide a computer program product, which stores a program of a positioning method for a positioning apparatus. The positioning apparatus is used to compute a self-position, and is able to communicate with a reference apparatus. The positioning apparatus comprises a transceiving unit, a storage unit and a processing unit. The storage unit is configured to store attenuating factor data. The processing unit is electrically connected to the transceiving unit and the storage unit respectively. The program comprises: a code A for enabling the transceiving unit to receive a RSSI from the reference apparatus; a code B for enabling the processing unit to retrieve an attenuating factor corresponding to the RSSI from the attenuating factor data; and a code C for enabling the processing unit to compute the self-position according to the RSSI and the attenuating factor.

According to the present invention, by communicating with the reference apparatus, the positioning apparatus receives an RSSI from the reference apparatus and, according to the RSSI, retrieves an attenuating factor corresponding to the RSSI from the attenuating factor data stored by the positioning apparatus. Then, the positioning apparatus computes a self-position of the positioning apparatus according to the RSSI and the attenuating factor. Thereby, the present invention can overcome the disadvantage of the conventional positioning method that a positioning error is caused because the signal propagation model does not conform to the actual path loss conditions. Furthermore, the positioning method conforms to the actual environmental factors and provides an improved positioning accuracy.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of the first embodiment of the present invention;

FIG. 2 is a schematic view illustrating communications between a positioning apparatus and reference apparatuses;

FIG. 3 is a line graph of attenuating factor data according to the present invention;

FIG. 4 is a line graph of RSSI as a function of a distance according to the present invention;

FIG. 5 is a line graph of an attenuating factor as a function of a distance according to the present invention; and

FIG. 6 is a flowchart of the second embodiment of the present invention.

### DETAILED DESCRIPTION

In the following descriptions, the present invention will be explained with reference to example embodiments thereof. However, these example embodiments are not intended to limit the present invention to any specific environment, example, embodiment, applications or particular implementations described in these embodiments. Therefore, the description of these example embodiments is only for the purpose of illustration rather than to limit the present invention. It should be appreciated that in the following embodiments and the attached drawings, elements unrelated to the present invention are omitted from depiction; and dimensional relationships among individual elements in the attached drawings are illustrated only for ease of understanding, but not to limit the actual scale.

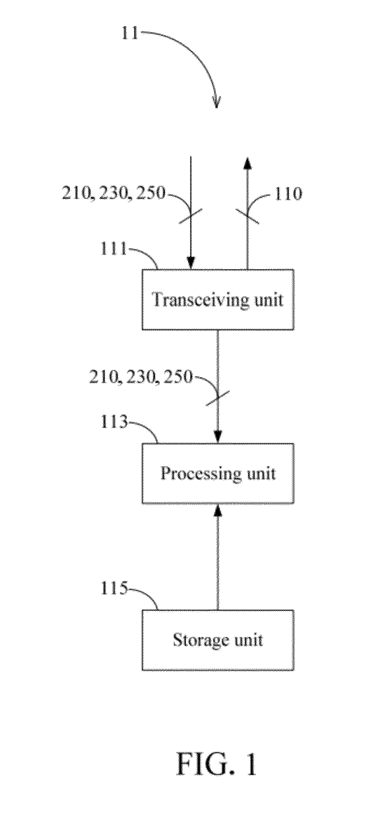

A first embodiment of the present invention is a positioning apparatus 11, which is schematically depicted in FIG. 1. The positioning apparatus 11 comprises a transceiving unit 111, a processing unit 113 and a storage unit 115. The transceiving unit 111 and the storage unit 115 are electrically connected to the processing unit 113 respectively. The transceiving unit 111 may be an antenna, a transceiver or some other component, which has transmitting and receiving capabilities and is well known to those of ordinary skill in the art, of the positioning apparatus 11. The processing unit 113 may be any of various processors, central processing units (CPUs), microprocessors, calculators or other devices with a computing capability and well known to those skilled in the art, either currently available or to be developed in the future. The storage unit 115 may be a memory, a floppy disk, a hard disk, a compact disk (CD), a mobile disk, a magnetic tape, a database accessible to networks, or any other storage media with the same function and well known to those skilled in the art.

In this embodiment, the positioning apparatus 11 is a mobile phone. In other embodiments, the positioning apparatus 11 may also be a tablet computer, a notebook computer, a personal digital assistant (PDA), a digital camera, a game console, a digital media player or some other wireless communication terminal with a wireless communication function. Implementations of the positioning apparatus 11 are not intended to limit the scope of the present invention.

The positioning apparatus of the present invention has a wireless communication function, and is able to communicate with one or a plurality of reference apparatuses with a wireless communication function. For example, the positioning apparatus may communicate with the reference apparatus(es) through Bluetooth transmissions, WiFi (Wireless Fidelity) transmissions, WiMAX (Worldwide Interoperability for Microwave Access) transmissions or other wireless communication technologies. Therefore, the communication method and communication protocol between the positioning apparatus and the reference apparatuses are not intended to limit the scope of the present invention.

It shall be particularly noted that the “reference apparatus” described in this specification means an apparatus with a positioning function, which may be a mobile phone, a tablet computer, a notebook computer, a personal digital assistant (PDA), a digital camera, a game console, a digital media player or some other wireless communication terminal with a positioning function. The implementations of the reference apparatus is not intended to limit the scope of the present invention.

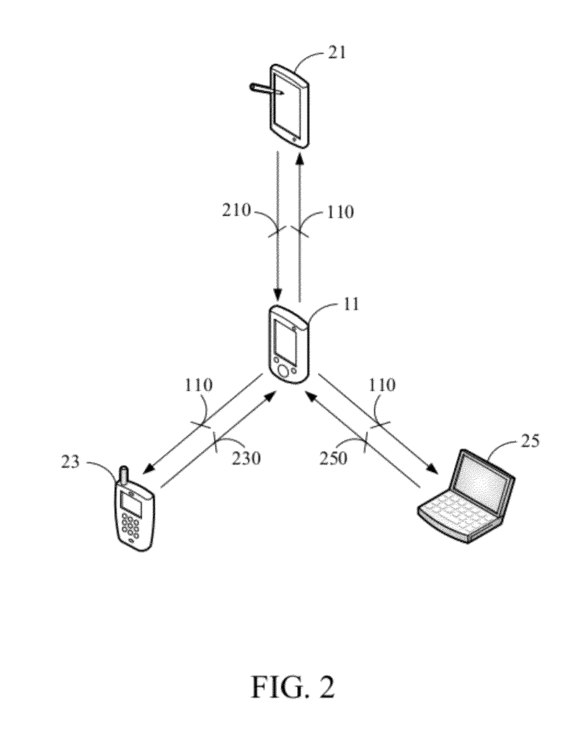

FIG. 2 illustrates a schematic view of the communications between the positioning apparatus of the present invention and the reference apparatuses. As shown in FIG. 2, the positioning apparatus 11 can communicate with a reference apparatus 21, a reference apparatus 23 and a reference apparatus 25 respectively. Hereinbelow, the positioning apparatus 11 of the present invention computes a self-position thereof.

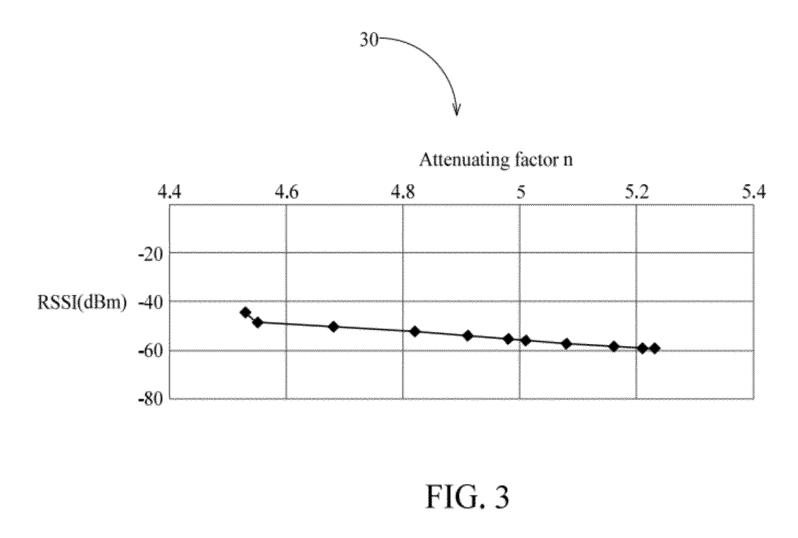

First, the storage unit 115 stores attenuating factor data 30. The attenuating factor data 30 represents corresponding relationships between an attenuating factor n and a received signal strength indicator (RSSI). FIG. 3 illustrates a line graph of the attenuating factor data 30, where the longitudinal axis represents the RSSI and the horizontal axis represents the attenuating factor n. From the attenuating factor data 30, the attenuating factor n that corresponds to an RSSI can be known.

Next, the method in which the attenuating factor data 30 is established and the meaning thereof will be described. It shall be firstly appreciated that a wireless signal transmitted for wireless communication will experience attenuation due to the influence of the propagation environment and the propagation distance. Generally, the further the propagation distance, the greater the attenuation extent of the wireless signal; also, the attenuation extent of the wireless signal varies with the propagation environment. However, the conventional wireless signal attenuation models all adopt a fixed attenuation factor, i.e., all use preset and fixed attenuation factor to compute a distance no matter how the propagation of the wireless signal is influenced by the actual environment. Consequently, as the influence of the actual environment on propagation of the wireless signal is not taken into account in the conventional wireless signal attenuation models, a considerable error tends to occur in the distance thus computed, thus leading to inaccuracy in the positioning.

Therefore, to faithfully reflect the influence of the actual environment on propagation of the wireless signal, a wireless signal attenuation model that takes influence of the actual environment into account must be established. Accordingly, in the present invention, the relationships between the wireless signal propagation distance and the wireless signal strength (i.e., the RSSI) is actually measured, and then the attenuating factor n that reflects the actual environment factors is computed according to the measurement results and the wireless signal attenuation model to establish the attenuating factor data 30.

Next, the method in which the measurement is made will be described. In the present invention, the relationships between the wireless signal propagation distance and the wireless signal strength are measured by means of a wireless signal transmitting apparatus (e.g., the positioning apparatus 11) and a wireless signal receiving apparatus (e.g., the reference apparatus 21). Specifically at first, the reference apparatus 21 is disposed at a predetermined distance from the positioning apparatus 11, and then a wireless signal is transmitted by a positioning apparatus 11. The reference apparatus 21 then receives the wireless signal and generates a measured RSSI according to the wireless signal. In a similar way, by sequentially changing the distance between the reference apparatus 21 and the positioning apparatus 11, the measured RSSIs of the wireless signal received by the positioning apparatus 11 when the reference apparatus 21 and the positioning apparatus 11 have different distances therebetween are measured respectively.

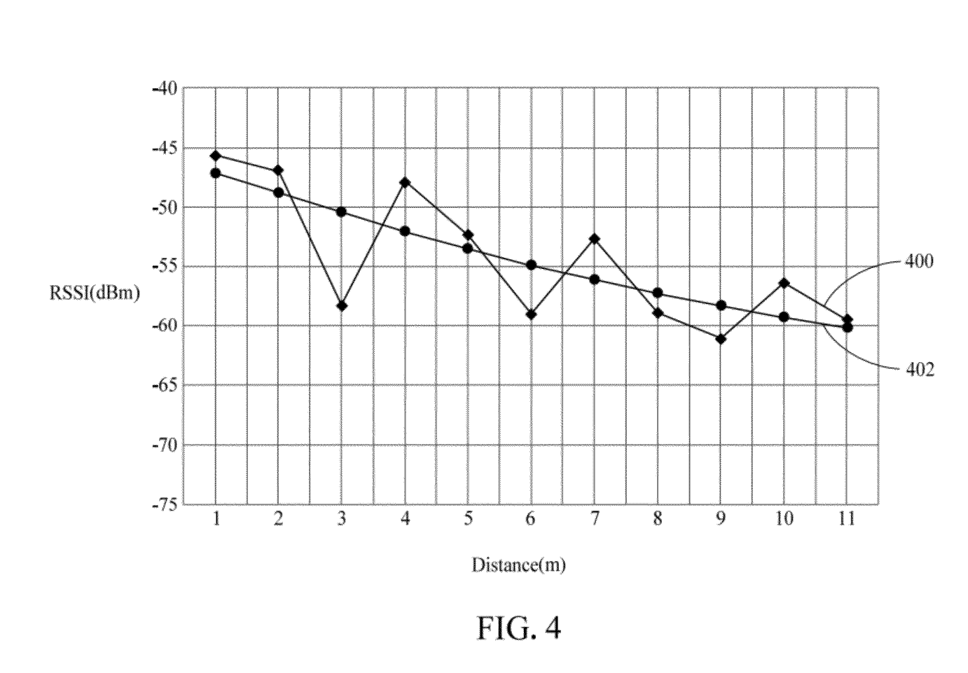

After the measured RSSIs at different distances are obtained, the relationships between the RSSI and the distance in a realistic environment can be known. FIG. 4 illustrates a line graph of the RSSI as a function of the distance, where the longitudinal axis represents the RSSI and the horizontal axis represents the distance. In this embodiment, the measurement is made once every meter within a distance ranges between 1 m and 11 m. FIG. 4 depicts a line graph 400 and a line graph 402, in which the line graph 400 is depicted according to the measured data and the line graph 402 is a smoothed line graph obtained by taking an approximating function of the line graph 400. In subsequent computations, data from the line graph 402 will be taken as a basis of the computation. Thus, the line graph 402 represents the attenuation characteristics of the wireless signal with influences of the realistic environment being taken into account.

After the relationships between the RSSI and the distance in the realistic environment is measured, the present invention further computes the attenuating factor n according to a wireless signal attenuating model. Specifically, the wireless signal attenuating model can be represented by Equation (1) as follows:

RSSI=−[10n log₁₀(d)+A] (1)

where, RSSI represents the received signal strength indicator; n represents the attenuating factor; d represents the distance between the transmitting terminal and the receiving terminal; A represents a received signal strength indicator when the distance between the transmitting terminal and the receiving terminal is 1 m, and is a constant used to describe an effect (e.g., the influence of the antenna gain on the RSSI) that is unrelated to the distance, in the RSSI.

According to the line graph 402 in FIG. 4, a distance value is substituted for d in Equation (1) and an RSSI corresponding to this distance value is substituted for RSSI in Equation (1). Because A is a constant, the attenuating factor n corresponding to this distance value can be computed. For example, as can be seen from the line graph 402, when the distance is 5 m, the RSSI is about −55 dBm; then by substituting d=5 and RSSI=−55 into Equation (1) respectively, the attenuating factor n can be computed to be about 5, and so on.

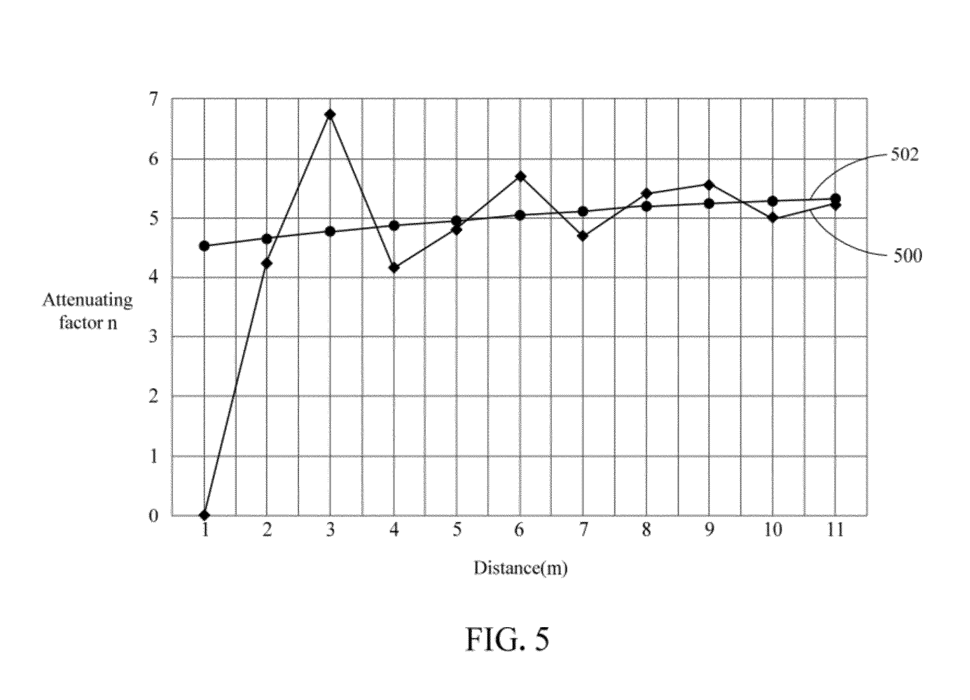

By substituting the individual distance values of FIG. 4 and their corresponding RSSIs into Equation (1), the relationships between the attenuating factor n and the distance can be computed. FIG. 5 illustrates a line graph of the attenuating factor n as a function of the distance, where the longitudinal axis represents the attenuating factor n and the horizontal axis represents the distance. FIG. 5 depicts a line graph 500 and a line graph 502, in which the line graph 500 is obtained through computation by substituting the data of the line graph 400 into Equation (1) and the line graph 502 is obtained through computation by substituting the data of the line graph 402 into Equation (1). That is, the line graph 500 is a line graph obtained through the computation according to the actually measured data, while the line graph 502 is a smoothed line graph obtained by taking an approximating function of the line graph 500. In subsequent computations, data from the line graph 502 will be taken as a basis of computation. Thus, the line graph 502 represents the attenuating factor that takes influences of the realistic environment into account.

As can be known from the above descriptions, FIG. 4 depicts the relationships between the RSSI and the distance, and FIG. 5 depicts the relationships between the attenuating factor and the distance. Thereby, according to the data of FIG. 4 and FIG. 5, the present invention can further establish the attenuating factor data 30 as shown in FIG. 3, i.e., the correspondence relationship between the RSSI and the attenuating factor.

Hereinbelow, the method in which the positioning apparatus 11 of the present invention computes a self-position will be described. In reference to both FIGS. 1 and 2, the positioning apparatus 11 transmits a request position signal 110 via the transceiving unit 111 in a broadcast. Then, the reference apparatus 21, the reference apparatus 23 and the reference apparatus 25 near the positioning apparatus 11 can receive the request position signal 110 respectively and generate an RSSI according to the request position signal 110 respectively.

Upon receiving the request position signal 110, the reference apparatus 21, the reference apparatus 23 and the reference apparatus 25 each transmit a response signal 210, a response signal 230 and a response signal 250 to the positioning apparatus 11 respectively in response to the request position signal 110. The response signal 210 comprises a received signal strength indicator RSSI₁ and position information P₁ of the reference apparatus 21; the response signal 230 comprises a received signal strength indicator RSSI₃ and position information P₃ of the reference apparatus 23; while the response signal 250 comprises a received signal strength indicator RSSI₅ and position information P₅ of the reference apparatus 25.

It shall be particularly noted that the received signal strength indicator RSSI₁ in the response signal 210 refers to a received signal strength indicator corresponding to the request position signal 110 received by the reference apparatus 21 when the reference apparatus 21 and the positioning apparatus 11 has a relative distance d₁ therebetween. The position information in the response signal 210 is obtained by the reference apparatus 21 through the positioning function thereof, and in this embodiment, the position information of the reference apparatus 21 is the coordinate information of the reference apparatus 21. Likewise, the received signal strength indicator RSSI₃ in the response signal 230 refers to a received signal strength indicator corresponding to the request position signal 110 received by the reference apparatus 23 when the reference apparatus 23 and the positioning apparatus 11 has a relative distance d₃ therebetween.

The position information in the response signal 230 is the coordinate information of the reference apparatus 23. Also likewise, the received signal strength indicator RSSI₅ in the response signal 250 refers to a received signal strength indicator corresponding to the request position signal 110 received by the reference apparatus 25 when the reference apparatus 25 and the positioning apparatus 11 has a relative distance d₅ therebetween. The position information in the response signal 250 is the coordinate information of the reference apparatus 25.

Upon receiving the response signal 210, the transceiving unit 111 of the positioning apparatus 11 transmits the response signal 210 to the processing unit 113. According to the received signal strength indicator RSSI₁ in the response signal 210, the processing unit 113 retrieves an attenuating factor n₁ corresponding to the received signal strength indicator RSSI₁ from the attenuating factor data 30 stored in the storage unit. Then, the processing unit 113 substitutes the received signal strength indicator RSSI₁ and the attenuating factor n₁ into Equation (1) to compute the relative distance d₁ between the positioning apparatus 11 and the reference apparatus 21.

Likewise, upon receiving the response signal 230, the transceiving unit 111 of the positioning apparatus 11 transmits the response signal 230 to the processing unit 113. According to the received signal strength indicator RSSI₃ in the response signal 230, the processing unit 113 retrieves an attenuating factor n₃ corresponding to the received signal strength indicator RSSI₃ from the attenuating factor data 30 stored in the storage unit. Then, the processing unit 113 substitutes the received signal strength indicator RSSI₃ and the attenuating factor n₃ into Equation (1) to compute the relative distance d₃ between the positioning apparatus 11 and the reference apparatus 23.

Also likewise, upon receiving the response signal 250, the transceiving unit 111 of the positioning apparatus 11 transmits the response signal 250 to the processing unit 113. According to the received signal strength indicator RSSI₅ in the response signal 250, the processing unit 113 retrieves an attenuating factor n₅ corresponding to the received signal strength indicator RSSI₅ from the attenuating factor data 30 stored in the storage unit. Then, the processing unit 113 substitutes the received signal strength indicator RSSI₅ and the attenuating factor n₅ into Equation (1) to compute the relative distance d₅ between the positioning apparatus 11 and the reference apparatus 25.

After the relative distance d₁, the relative distance d₃ and the relative distance d₅ have been computed, the processing unit 113 can compute a self-position of the positioning apparatus 11 through a positioning algorithm according to the relative distance d₁, the relative distance d₃ and the relative distance d₅, the position information P₁ of the reference apparatus 21, the position information P₃ of the reference apparatus 23 and the position information P₅ of the reference apparatus 25. In this embodiment, the processing unit 113 computes the self-position of the positioning apparatus 11 through a trilateration algorithm.

Specifically, assuming that the self-position of the positioning apparatus 11 is P₀=(x, y), the position information of the reference apparatus 21 is P₁=(x₁, y₁), the position information of the reference apparatus 23 is P₃=(x₃, y₃) and the position information of the reference apparatus 25 is P₅=(x₅, y₅), then the following simultaneous equations (2) can be obtained according to the trilateration algorithm:

$$\{ \begin{matrix}{( x - {x}_{1} )}^{2} + {( y - {y}_{1} )}^{2} = {d}_{1}^{2} \\ {( x - {x}_{3} )}^{2} + {( y - {y}_{3} )}^{2} = {d}_{3}^{2} \\ {( x - {x}_{5} )}^{2} + {( y - {y}_{5} )}^{2} = {d}_{5}^{2}\end{matrix} \qquad ( 2 )$$

Next, the processing unit 113 solves simultaneous equations (2) by means of the following Equation (3) to Equation (5):

$$\begin{matrix} \{ \begin{matrix}{xx}_{1} + {yy}_{1} - {xx}_{5} - {yy}_{5} = \frac{1}{2} ( {d}_{5}^{2} - {x}_{5}^{2} - {y}_{5}^{2} + {x}_{1}^{2} + {y}_{1}^{2} - {d}_{1}^{2} ) \\ {xx}_{3} + {yy}_{3} - {xx}_{5} - {yy}_{5} = \frac{1}{2} ( {d}_{5}^{2} - {x}_{5}^{2} - {y}_{5}^{2} + {x}_{3}^{2} + {y}_{3}^{2} - {d}_{3}^{2} )\end{matrix} & ( 3 ) \\ [ \begin{matrix}{x}_{1} - {x}_{5} & {y}_{1} - {y}_{5} \\ {x}_{3} - {x}_{5} & {y}_{3} - {y}_{5}\end{matrix} ] [ \begin{matrix}x \\ y\end{matrix} ] = \frac{1}{2} [ \begin{matrix}{d}_{5}^{2} - {x}_{5}^{2} - {y}_{5}^{2} + {x}_{1}^{2} + {y}_{1}^{2} - {d}_{1}^{2} \\ {d}_{5}^{2} - {x}_{5}^{2} - {y}_{5}^{2} + {x}_{3}^{2} + {y}_{3}^{2} - {d}_{3}^{2}\end{matrix} ] & ( 4 ) \\ [ \begin{matrix}x \\ y\end{matrix} ] = {{( {[ \begin{matrix}\begin{matrix}{x}_{1} - {x}_{5} & {y}_{1} - {y}_{5}\end{matrix} \\ \begin{matrix}{x}_{3} - {x}_{5} & {y}_{3} - {y}_{5}\end{matrix}\end{matrix} ]}^{T} [ \begin{matrix}{x}_{1} - {x}_{5} & {y}_{1} - {y}_{5} \\ {x}_{3} - {x}_{5} & {y}_{3} - {y}_{5}\end{matrix} ] )}^{- 1} [ \begin{matrix}{x}_{1} - {x}_{5} & {y}_{1} - {y}_{5} \\ {x}_{3} - {x}_{5} & {y}_{3} - {y}_{5}\end{matrix} ]}^{T} \times \frac{1}{2} [ \begin{matrix}{d}_{5}^{2} - {x}_{5}^{2} - {y}_{5}^{2} + {x}_{1}^{2} + {y}_{1}^{2} - {d}_{1}^{2} \\ {d}_{5}^{2} - {x}_{5}^{2} - {y}_{5}^{2} + {x}_{3}^{2} + {y}_{3}^{2} - {d}_{3}^{2}\end{matrix} ] & ( 5 )\end{matrix}$$

Accordingly, the self-position of the positioning apparatus 11, i.e., the coordinate position (x, y) of the positioning apparatus 11 can be computed by the processing unit 113.

It shall be particularly noted that in this embodiment, the positioning apparatus communicates with three reference apparatuses to acquire the position information of the three reference apparatuses, computes the distances from the individual reference apparatuses, and finally computes the self-position of the positioning apparatus by use of a trilateration algorithm. In other embodiments, the positioning apparatus may also communicate with one or a plurality reference apparatuses to acquire the position information of the reference apparatus(es), computes the distance(s) from the individual apparatus(es), and computes the self-position of the positioning apparatus by use of other positioning algorithms. Therefore, the number of the reference apparatus(es) and the positioning algorithm used are not intended to limit the scope of the present invention.

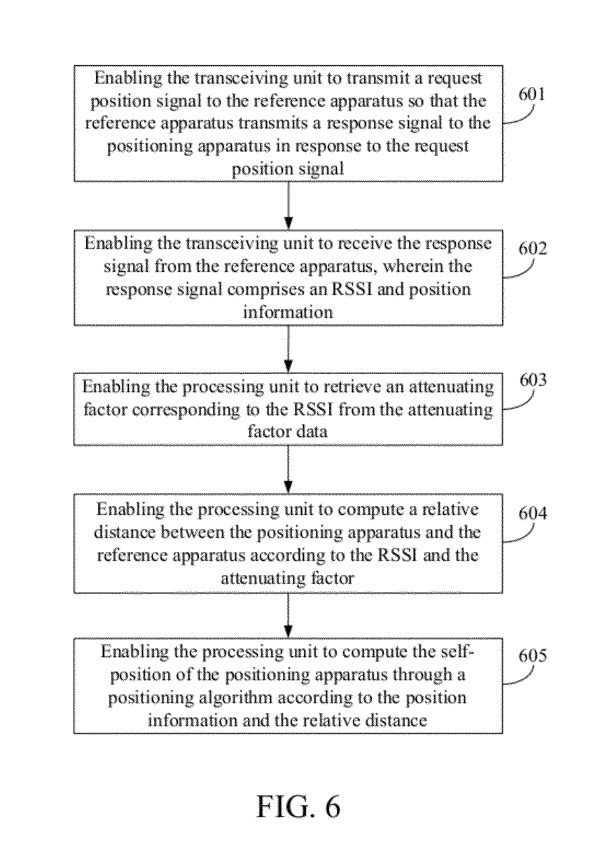

A second embodiment of the present invention is as shown in FIG. 6, which is a positioning method for the positioning apparatus as described in the first embodiment. The positioning apparatus is configured to compute a self-position, and is able to communicate with a reference apparatus. The positioning apparatus comprises a transceiving unit, a storage unit and a processing unit. The processing unit is electrically connected to the transceiving unit and the storage unit respectively.

The positioning method described in the second embodiment may be implemented by a computer program product. When the computer program product is loaded into the positioning system via a computer and a plurality of codes comprised therein is executed, the positioning method described in the second embodiment can be accomplished. The computer program product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

FIG. 6 depicts a flowchart of the positioning method of the second embodiment. First, step 601 is executed to enable the transceiving unit to transmit a request position signal to the reference apparatus so that the reference apparatus transmits a response signal to the positioning apparatus in response to the request position signal. Then, step 602 is executed to enable the transceiving unit to receive the response signal from the reference apparatus. The response signal comprises an RSSI and position information, with the RSSI being generated by the reference apparatus according to the request position signal.

The storage unit of the positioning apparatus stores attenuating factor data. The attenuating factor data is established according to a distance and a measured RSSI. Then, step 603 is executed to enable the processing unit to retrieve an attenuating factor corresponding to the RSSI from the attenuating factor data. Step 604 is executed to enable the processing unit to compute a relative distance between the positioning apparatus and the reference apparatus according to the RSSI and the attenuating factor. Finally, step 605 is executed to enable the processing unit to compute the self-position of the positioning apparatus through a positioning algorithm according to the position information and the relative distance.

In addition to the aforesaid steps, the second embodiment can also execute all the operations and functions set forth in the first embodiment. The method in which the second embodiment executes these operations and functions will be readily appreciated by those of ordinary skill in the art based on the explanation of the first embodiment, and thus will not be further described herein.

According to the above descriptions, in the present invention, the positioning apparatus transmits a request position signal, and a nearby reference apparatus transmits a response signal to the positioning apparatus in response to the request position signal. According to an RSSI in the response signal, the positioning apparatus retrieves an attenuating factor from attenuating data that was established in advance, and computes a relative distance between the positioning apparatus and the reference apparatus according to the attenuating factor and the RSSI.

Finally, the positioning apparatus computes the self-position thereof through a positioning algorithm according to the relative distance and position information in the response signal. Thereby, the present invention can overcome the disadvantage of the conventional positioning method that a positioning error is caused because the signal propagation model doesn't conform to the actual path loss conditions. Furthermore, the positioning method of the present invention conforms to the actual environmental factors and provides an improved positioning accuracy.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A positioning apparatus being used to compute a self-position, the positioning apparatus being able to communicate with a reference apparatus, comprising:
a transceiving unit, being configured to receive a received signal strength indicator (RSSI) from the reference apparatus;
a storage unit, being configured to store attenuating factor data; and
a processing unit electrically connected to the transceiving unit and the storage unit respectively, being configured to retrieve an attenuating factor corresponding to the RSSI from the attenuating factor data and compute the self-position according to the RSSI and the attenuating factor.

2. The positioning apparatus as claimed in claim 1, wherein the attenuating factor data is established according to a distance and a measured RSSI.

3. The positioning apparatus as claimed in claim 1, wherein the transceiving unit is further configured to transmit a request position signal to the reference apparatus so that the reference apparatus transmits the RSSI to the positioning apparatus in response to the request position signal.

4. The positioning apparatus as claimed in claim 3, wherein the RSSI is generated by the reference apparatus according to the request position signal.

5. The positioning apparatus as claimed in claim 1, wherein the transceiving unit is further configured to receive a piece of position information of the reference apparatus from the reference apparatus, the processing unit computes a relative distance between the positioning apparatus and the reference apparatus according to the RSSI and the attenuating factor and computes the self-position by a positioning algorithm according to the position information and the relative distance.

6. A positioning method for a positioning apparatus, the positioning apparatus being used to compute a self-position, being able to communicate with a reference apparatus, and comprising a transceiving unit, a storage unit and a processing unit, the storage unit being configured to store attenuating factor data, the processing unit being electrically connected to the transceiving unit and the storage unit respectively, the positioning method comprising the steps of:
(a) enabling the transceiving unit to receive a RSSI from the reference apparatus;
(b) enabling the processing unit to retrieve an attenuating factor corresponding to the RSSI from the attenuating factor data; and
(c) enabling the processing unit to compute the self-position according to the RSSI and the attenuating factor.

7. The positioning method as claimed in claim 6, wherein the attenuating factor data is established according to a distance and a measured RSSI.

8. The positioning method as claimed in claim 6, further comprising the step of:
(d) enabling the transceiving unit to transmit a request position signal to the reference apparatus so that the reference apparatus transmits the RSSI to the positioning apparatus in response to the request position signal.

9. The positioning method as claimed in claim 8, wherein the RSSI is generated by the reference apparatus according to the request position signal.

10. The positioning method as claimed in claim 6, further comprising the steps of:
(e) enabling the transceiving unit to receive a piece of position information of the reference apparatus from the reference apparatus;
(f) enabling the processing unit to compute a relative distance between the positioning apparatus and the reference apparatus according to the RSSI and the attenuating factor; and
(g) enabling the processing unit to compute the self-position by a positioning algorithm according to the position information and the relative distance.

11. A computer program product, storing a program of a positioning method for a positioning apparatus, the positioning apparatus being used to compute a self-position, being able to communicate with a reference apparatus, and comprising a transceiving unit, a storage unit and a processing unit, the storage unit being configured to store attenuating factor data, the processing unit being electrically connected to the transceiving unit and the storage unit respectively, the program comprising:
a code A for enabling the transceiving unit to receive a RSSI from the reference apparatus;
a code B for enabling the processing unit to retrieve an attenuating factor corresponding to the RSSI from the attenuating factor data; and
a code C for enabling the processing unit to compute the self-position according to the RSSI and the attenuating factor.

12. The computer program product as claimed in claim 11, wherein the attenuating factor data is established according to a distance and a measured RSSI.

13. The computer program product as claimed in claim 11, wherein the program further comprises:
a code D for enabling the transceiving unit to transmit a request position signal to the reference apparatus so that the reference apparatus transmits the RSSI to the positioning apparatus in response to the request position signal.

14. The computer program product as claimed in claim 13, wherein the RSSI is generated by the reference apparatus according to the request position signal.

15. The computer program product as claimed in claim 11, wherein the program further comprises:
a code E for enabling the transceiving unit to receive a piece of position information of the reference apparatus from the reference apparatus;
a code F for enabling the processing unit to compute a relative distance between the positioning apparatus and the reference apparatus according to the RSSI and the attenuating factor; and
a code G for enabling the processing unit to compute the self-position by a positioning algorithm according to the position information and the relative distance.
